(19) United States
(12) Patent Application Publication
(10) Pub. No.: US 2026/0134136 A1
(43) Pub. Date: May 14, 2026

(54) ENCRYPTED ARTIFICIAL INTELLIGENCE NETWORK

(71) Applicant: Lenovo (United States) Inc., Morrisville, NC (US)

(72) Inventors: Igor Stolbikov, Apex, NC (US); Scott Li, Cary, NC (US); John W. Nicholson, Cary, NC (US); Daryl C. Cromer, Raleigh, NC (US)

(21) Appl. No.: 18/943,562

(22) Filed: Nov. 11, 2024

(51) Int. Cl. G06F 21/62; G06F 21/60

(52) U.S. Cl. CPC G06F 21/6227; G06F 21/602; G06F 2221/2107

(57) ABSTRACT

Users in an artificial intelligence (AI) system are associated with a tenant in a large language model (LLM). The tenant is associated with a particular execution thread in the LLM. The particular execution thread includes branches, and each branch associated with its own branch encryption key. The tenant is associated with one or more AI policies in the LLM. Updates related to the tenant are associated with changes to the LLM in a particular branch of the plurality of branches in the particular execution thread. A core file system in the AI system is associated with a file encryption key. The file encryption key and the branch encryption key are used to aggregate, from a root of the particular branch to a specific leaf of the particular branch, each of multiple subbranches of the particular branch, thereby generating a tenant specific virtual LLM model.

### TECHNICAL FIELD

Embodiments described herein relate to artificial intelligence (AI), and in an embodiment, but not by way of limitation, AI in connection with a multi-branched network and encryption.

### BACKGROUND

Many artificial intelligence systems use large language models (LLM) and have many tenants using the LLM. A problem with multiple tenants using LLMs is LLM data leakage. Specifically, LLMs are trained on large text datasets that may belong to multiple entities. The use of an LLM can cause a risk of data leakage or sensitive information disclosure to one or more of the tenants. There are several recent examples of massive data leakage, for example one involving ChatGPT from OpenAI.

There are some known methods to deal with this data leakage among tenants. However, these methods are costly and not efficient. For example, the SHARE-ALL or SHARE-NOTHING approaches are not sufficient to satisfy different complex use cases. The base models consist of billions of weights, but tenants may want to partially train the model weights for their domain. Some model weights may be frozen, but others may change. Also, the vector databases that are used to go between language and embedding LLM actually work on a numerical vector in embedding space, not on words or letters. Tenants may extend for new words, or change some channels of embedding.

Second, data masking and obfuscation techniques of the SHARE-ALL approach are employed to enhance data security. However, these methods may not always guarantee sufficient isolation between tenants. For instance, even if encrypted, encrypted data values may be visible to multiple tenants, and it may be possible to identify patterns even if the data are not readable. Similarly, creating a complete copy of an LLM and assigning the LLM on a per tenant in the SHARE-NOTHING approach is a very costly, especially for extra-large LLMs.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIG. 1 is a block diagram of a system and method to segregate an artificial intelligence (AI) system using multiple branches and encryption.

FIG. 2 is a block diagram of a computer architecture upon which one or more of the embodiments disclosed herein can execute.

### DETAILED DESCRIPTION

An embodiment relates to a novel artificial intelligence (AI) encryption method that is coupled with encryption-based segregation and the leveraging of branching to maintain file distinctions according to tenant policies and encryption keys. Upon login, users are associated with one specific tenant, which executes within its dedicated processes or threads. A user may be part of one large tenant with many users, or the user may also have multiple personal distinct models (e.g., one at home, one for work, one for a particular hobby, but the user can only use one at a time. Changes to the AI model specific to a tenant are stored in uniquely encrypted files, secured with the tenant's specific key. A policy engine can act as an AI agent, and the engine can make decisions based on data sensitivity and tenant policies.

Each tenant is linked to one or more branches, and each branch possesses a distinct cryptographic key, tenant ID, date, and other attributes. Accessing the complete branch line requires the cryptographic keys from all branches within it. In an embodiment, the AI process relies on a tenant's key management solution. Both client-side and server-side key management solutions are viable options.

An embodiment permits tenants to furnish a key, thereby granting exclusive access to their data. Branch encryption segregation can be policy-driven, offering the flexibility to channel data either to a core/main file system shared by all or to a segregated branch. An added advantage is the ability to preserve historical models and roll back to specific dates or moments in time.

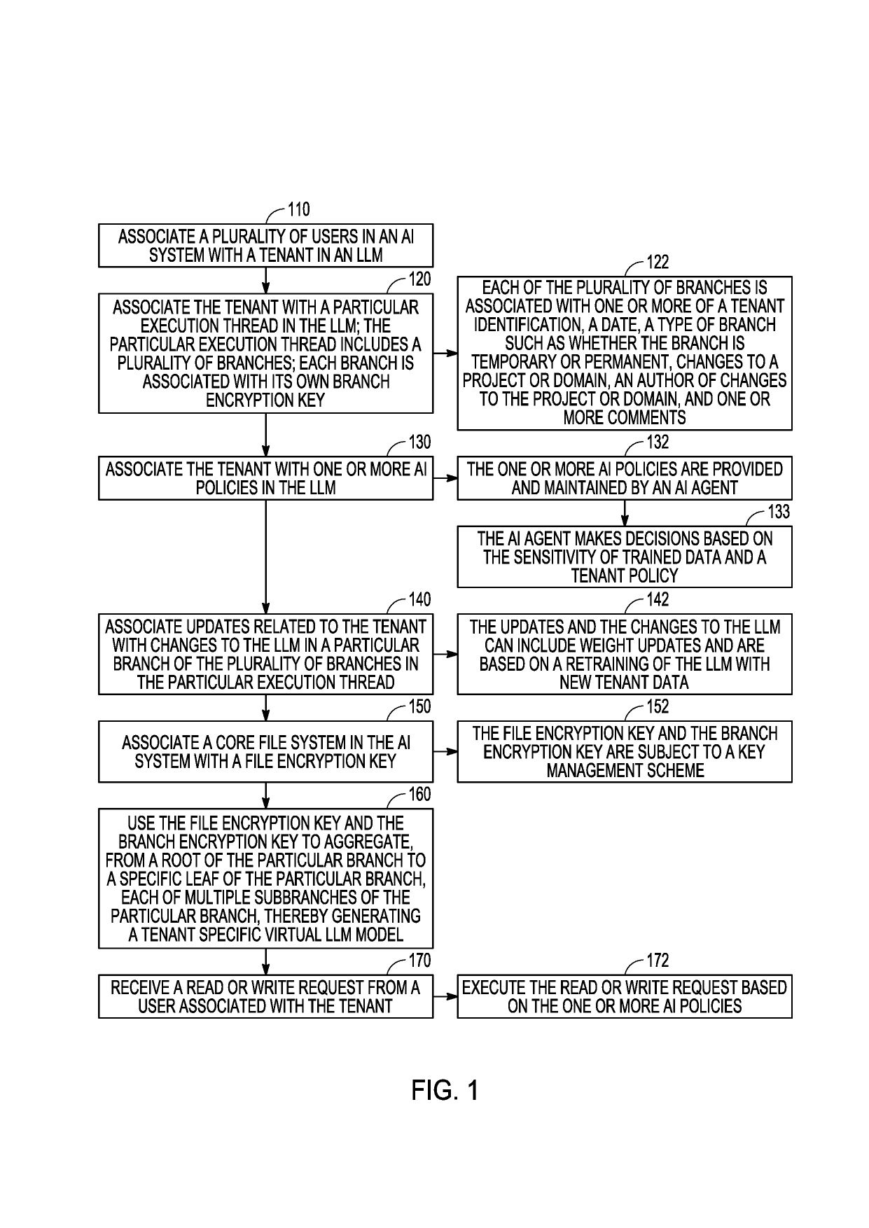

FIG. 1 is a block diagram illustrating operations and features of an AI system that includes encryption. FIG. 1 includes a number of process and feature blocks 110 – 172. Though arranged substantially serially in the example of FIG. 1, other examples may reorder the blocks, omit one or more blocks, and/or execute two or more blocks in parallel using multiple processors or a single processor organized as two or more virtual machines or sub-processors.

Referring now to FIG. 1, at 110, a plurality of users in an artificial intelligence (AI) system is associated with a tenant in a large language model (LLM). At 120, the tenant is associated with a particular execution thread in the LLM. The particular execution thread includes a plurality of branches, and each branch is associated with its own branch encryption key. At 122, each of the plurality of branches is associated with one or more of a tenant identification, a date, a type of branch such as whether the branch is temporary or permanent, changes to a project or domain, an author of changes to the project or domain, one or more comments, and other information and data.

At 130, the tenant is associated with one or more AI policies in the LLM. As indicated at 132, the one or more AI policies can be provided and maintained by an AI agent. And as further indicated as 133, the AI agent is able to make decisions based on the sensitivity of trained data and a tenant policy.

At 140, updates related to the tenant are associated with changes to the LLM in a particular branch of the plurality of branches in the particular execution thread. As indicated at 142, the updates and the changes to the LLM can include weight updates and are based on a retraining of the LLM with new tenant data. The changes can further include a fine-tuning of the LLM with the tenant updates. Each tenant fine-tuning is in a particular tenant branch.

At 150, a core file system in the AI system is associated with a file encryption key. At 152, the file encryption key and the branch encryption key are subject to a key management scheme.

And at 160, the file encryption key and the branch encryption key are used to aggregate, from a root of the particular branch to a specific leaf of the particular branch, each of multiple subbranches of the particular branch, thereby generating a tenant specific virtual LLM model. A root is the common model / common ancestor of all tenants; the leaf is a particular tenant. Each branch is the common modifications of the root for multiple tenants.

At 170, a read or write request is received from a user associated with the tenant, and at 172, the read or write request is executed based on the one or more AI policies. It is noted that there is currently a leaf present, the writing operation will cause the creation of a new branch, and anything downstream of an old value will continue to use the old value.

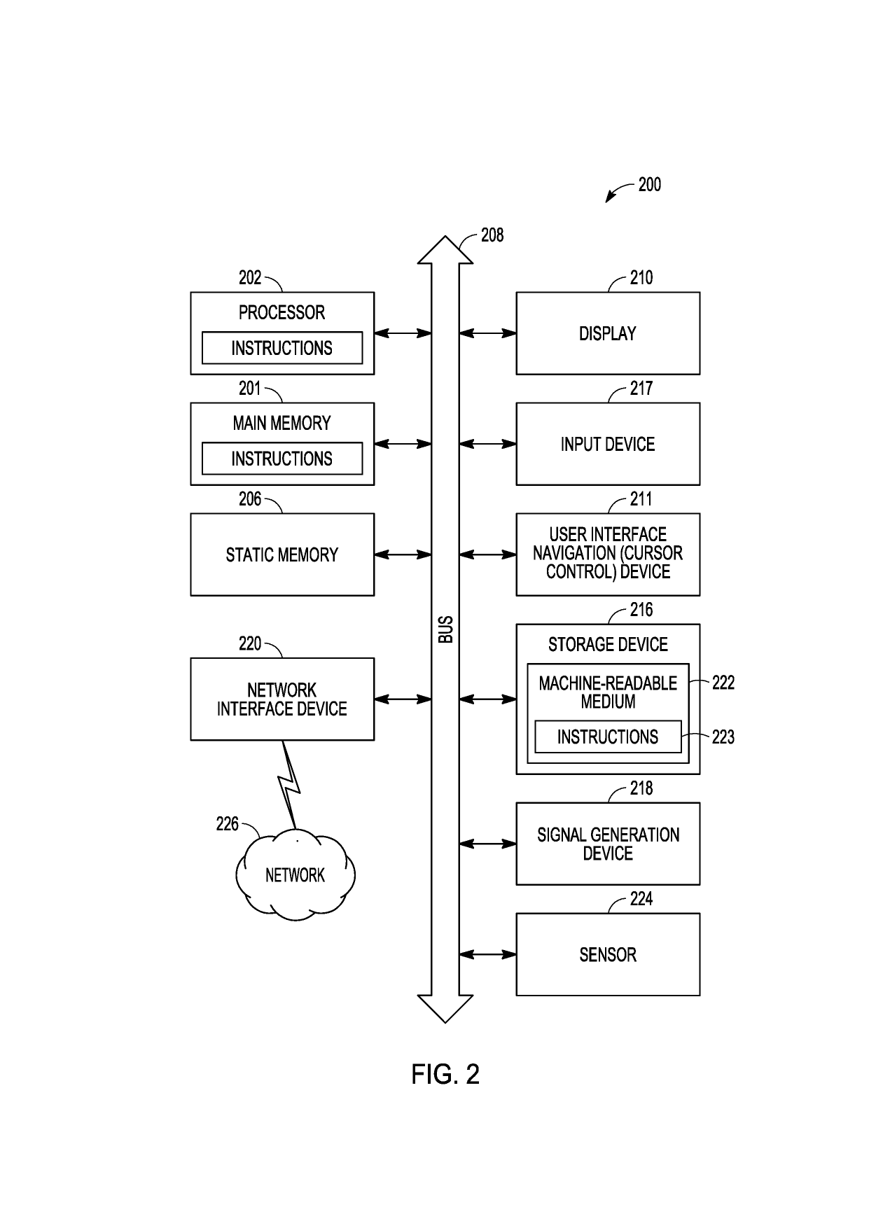

FIG. 2 is a block diagram illustrating a computing and communications platform 200 in the example form of a general-purpose machine on which some or all the operations of FIG. 1 may be carried out according to various embodiments. In certain embodiments, programming of the computing platform 200 according to one or more particular algorithms produces a special-purpose machine upon execution of that programming. In a networked deployment, the computing platform 200 may operate in the capacity of either a server or a client machine in server-client network environments, or it may act as a peer machine in peer-to-peer (or distributed) network environments.

Example computing platform 200 includes at least one processor 202 (e.g., a central processing unit (CPU), a graphics processing unit (GPU) or both, processor cores, compute nodes, etc.), a main memory 201 and a static memory 206, which communicate with each other via a link 208 (e.g., bus). The computing platform 200 may further include a video display unit 210, input devices 217 (e.g., a keyboard, camera, microphone), and a user interface (UI) navigation device 211 (e.g., mouse, touchscreen). The computing platform 200 may additionally include a storage device 216 (e.g., a drive unit), a signal generation device 218 (e.g., a speaker), a sensor 224, and a network interface device 220 coupled to a network 226.

The storage device 216 includes a non-transitory machine-readable medium 222 on which is stored one or more sets of data structures and instructions 223 (e.g., software) embodying or utilized by any one or more of the methodologies or functions described herein. The instructions 223 may also reside, completely or at least partially, within the main memory 201, static memory 206, and/or within the processor 202 during execution thereof by the computing platform 200, with the main memory 201, static memory 206, and the processor 202 also constituting machine-readable media.

While the machine-readable medium 222 is illustrated in an example embodiment to be a single medium, the term “machine-readable medium” may include a single medium or multiple media (e.g., a centralized or distributed database, and/or associated caches and servers) that store the one or more instructions 223. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

### Examples

Example No. 1 is a process comprising associating a plurality of users in an artificial intelligence (AI) system with a tenant in a large language model (LLM); associating the tenant with a particular execution thread in the LLM, the particular execution thread comprising a plurality of branches, each branch associated with its own branch encryption key; associating the tenant with one or more AI policies in the LLM; associating updates related to the tenant with changes to the LLM in a particular branch of the plurality of branches in the particular execution thread; associating a core file system in the AI system with a file encryption key; and using the file encryption key and the branch encryption key, aggregating from a root of the particular branch to a specific leaf of the particular branch each of multiple subbranches of the particular branch, thereby generating a tenant specific virtual LLM model.

Example No. 2 includes all the features of Example No. 1, and optionally includes a process including associating each of the plurality of branches with a tenant identification, a date, a type of branch, changes to a project or domain, an author of changes to the project or domain, and one or more comments.

Example No. 3 includes all the features of Example Nos. 1-2, and optionally includes a process wherein the file encryption key and the branch encryption key are subject to a key management scheme.

Example No. 4 includes all the features of Example Nos. 1-3, and optionally includes a process including receiving a read or write request from a user associated with the tenant, and executing the read or write request based on the one or more AI policies.

Example No. 5 includes all the features of Example Nos. 1-4, and optionally includes a process wherein the one or more AI policies are provided and maintained by an AI agent.

Example No. 6 includes all the features of Example Nos. 1-5, and optionally includes a process wherein the AI agent makes decisions based on sensitivity of trained data and a tenant policy.

Example No. 7 includes all the features of Example Nos. 1-6, and optionally includes a process wherein the updates and the changes to the LLM comprise weight updates and are based on a retraining of the LLM with new tenant data.

Example No. 8 is a non-transitory machine-readable medium comprising instructions that when executed by a processor execute a process comprising associating a plurality of users in an artificial intelligence (AI) system with a tenant in a large language model (LLM); associating the tenant with a particular execution thread in the LLM, the particular execution thread comprising a plurality of branches, each branch associated with its own branch encryption key; associating the tenant with one or more AI policies in the LLM; associating updates related to the tenant with changes to the LLM in a particular branch of the plurality of branches in the particular execution thread; associating a core file system in the AI system with a file encryption key; and using the file encryption key and the branch encryption key, aggregating from a root of the particular branch to a specific leaf of the particular branch each of multiple subbranches of the particular branch, thereby generating a tenant specific virtual LLM model.

Example No. 9 includes all the features of Example No. 8, and optionally includes machine-readable medium including instructions for associating each of the plurality of branches with a tenant identification, a date, a type of branch, changes to a project or domain, an author of changes to the project or domain, and one or more comments.

Example No. 10 includes all the features of Example Nos. 8-9, and optionally includes a machine-readable medium wherein the file encryption key and the branch encryption key are subject to a key management scheme.

Example No. 11 includes all the features of Example Nos. 8-10, and optionally includes a machine-readable medium including instructions for receiving a read or write request from a user associated with the tenant, and executing the read or write request based on the one or more AI policies.

Example No. 12 includes all the features of Example Nos. 8-11, and optionally includes a machine-readable medium wherein the one or more AI policies are provided and maintained by an AI agent.

Example No. 13 includes all the features of Example Nos. 8-12, and optionally includes a machine-readable medium wherein the AI agent makes decisions based on sensitivity of trained data and a tenant policy.

Example No. 14 includes all the features of Example Nos. 8-13, and optionally includes a machine-readable medium wherein the updates and the changes to the LLM comprise weight updates and are based on a retraining of the LLM with new tenant data.

Example No. 15 is a system that includes a computer processor; and a computer memory coupled to the computer processor; wherein the computer processor and computer memory are operable for associating a plurality of users in an artificial intelligence (AI) system with a tenant in a large language model (LLM); associating the tenant with a particular execution thread in the LLM, the particular execution thread comprising a plurality of branches, each branch associated with its own branch encryption key; associating the tenant with one or more AI policies in the LLM; associating updates related to the tenant with changes to the LLM in a particular branch of the plurality of branches in the particular execution thread; associating a core file system in the AI system with a file encryption key; and using the file encryption key and the branch encryption key, aggregating from a root of the particular branch to a specific leaf of the particular branch each of multiple subbranches of the particular branch, thereby generating a tenant specific virtual LLM model.

Example No. 16 includes all the features of Example No. 15, and optionally includes a system wherein the system is operable for associating each of the plurality of branches with a tenant identification, a date, a type of branch, changes to a project or domain, an author of changes to the project or domain, and one or more comments.

Example No. 17 includes all the features of Example Nos. 15-16, and optionally includes a system wherein the file encryption key and the branch encryption key are subject to a key management scheme.

Example No. 18 includes all the features of Example Nos. 15-17, and optionally includes a system wherein the system is operable for receiving a read or write request from a user associated with the tenant, and executing the read or write request based on the one or more AI policies.

Example No. 19 includes all the features of Example Nos. 15-18, and optionally includes a system wherein the one or more AI policies are provided and maintained by an AI agent; and wherein the AI agent makes decisions based on sensitivity of trained data and a tenant policy.

Example No. 20 includes all the features of Example Nos. 15-19, and optionally includes a system wherein the updates and the changes to the LLM comprise weight updates and are based on a retraining of the LLM with new tenant data.

1. A process comprising:
associating a plurality of users in an artificial intelligence (AI) system with a tenant in a large language model (LLM);
associating the tenant with a particular execution thread in the LLM, the particular execution thread comprising a plurality of branches, each branch associated with its own branch encryption key;
associating the tenant with one or more AI policies in the LLM;
associating updates related to the tenant with changes to the LLM in a particular branch of the plurality of branches in the particular execution thread;
associating a core file system in the AI system with a file encryption key; and
using the file encryption key and the branch encryption key, aggregating from a root of the particular branch to a specific leaf of the particular branch each of multiple subbranches of the particular branch, thereby generating a tenant specific virtual LLM model.

2. The process of claim 1, comprising associating each of the plurality of branches with a tenant identification, a date, a type of branch, changes to a project or domain, an author of changes to the project or domain, and one or more comments.

3. The process of claim 1, wherein the file encryption key and the branch encryption key are subject to a key management scheme.

4. The process of claim 1, comprising receiving a read or write request from a user associated with the tenant, and executing the read or write request based on the one or more AI policies.

5. The process of claim 1, wherein the one or more AI policies are provided and maintained by an AI agent.

6. The process of claim 5, wherein the AI agent makes decisions based on sensitivity of trained data and a tenant policy.

7. The process of claim 1, wherein the updates and the changes to the LLM comprise weight updates and are based on a retraining of the LLM with new tenant data.

8. A non-transitory machine-readable medium comprising instructions that when executed by a processor execute a process comprising:
associating a plurality of users in an artificial intelligence (AI) system with a tenant in a large language model (LLM);
associating the tenant with a particular execution thread in the LLM, the particular execution thread comprising a plurality of branches, each branch associated with its own branch encryption key;
associating the tenant with one or more AI policies in the LLM;
associating updates related to the tenant with changes to the LLM in a particular branch of the plurality of branches in the particular execution thread;
associating a core file system in the AI system with a file encryption key; and
using the file encryption key and the branch encryption key, aggregating from a root of the particular branch to a specific leaf of the particular branch each of multiple subbranches of the particular branch, thereby generating a tenant specific virtual LLM model.

9. The non-transitory machine-readable medium of claim 8, comprising instructions for associating each of the plurality of branches with a tenant identification, a date, a type of branch, changes to a project or domain, an author of changes to the project or domain, and one or more comments.

10. The non-transitory machine-readable medium of claim 8, wherein the file encryption key and the branch encryption key are subject to a key management scheme.

11. The non-transitory machine-readable medium of claim 8, comprising instructions for receiving a read or write request from a user associated with the tenant, and executing the read or write request based on the one or more AI policies.

12. The non-transitory machine-readable medium of claim 8, wherein the one or more AI policies are provided and maintained by an AI agent.

13. The non-transitory machine-readable medium of claim 12, wherein the AI agent makes decisions based on sensitivity of trained data and a tenant policy.

14. The non-transitory machine-readable medium of claim 8, wherein the updates and the changes to the LLM comprise weight updates and are based on a retraining of the LLM with new tenant data.

15. A system comprising:
a computer processor; and
a computer memory coupled to the computer processor;
wherein the computer processor and computer memory are operable for:
associating a plurality of users in an artificial intelligence (AI) system with a tenant in a large language model (LLM);
associating the tenant with a particular execution thread in the LLM, the particular execution thread comprising a plurality of branches, each branch associated with its own branch encryption key;
associating the tenant with one or more AI policies in the LLM;
associating updates related to the tenant with changes to the LLM in a particular branch of the plurality of branches in the particular execution thread;
associating a core file system in the AI system with a file encryption key; and
using the file encryption key and the branch encryption key, aggregating from a root of the particular branch to a specific leaf of the particular branch each of multiple subbranches of the particular branch, thereby generating a tenant specific virtual LLM model.

16. The system of claim 15, wherein the system is operable for associating each of the plurality of branches with a tenant identification, a date, a type of branch, changes to a project or domain, an author of changes to the project or domain, and one or more comments.

17. The system of claim 15, wherein the file encryption key and the branch encryption key are subject to a key management scheme.

18. The system of claim 15, wherein the system is operable for receiving a read or write request from a user associated with the tenant, and executing the read or write request based on the one or more AI policies.

19. The system of claim 15, wherein the one or more AI policies are provided and maintained by an AI agent; and wherein the AI agent makes decisions based on sensitivity of trained data and a tenant policy.

20. The system of claim 15, wherein the updates and the changes to the LLM comprise weight updates and are based on a retraining of the LLM with new tenant data.
